(19) United States
(12) Patent Application Publication
(10) Pub. No.: US 2025/0198231 A1
(43) Pub. Date: Jun. 19, 2025

(54) SOLID CORE DOOR WITH DOVETAIL JOINTS AND METHOD OF MANUFACTURING THE SAME

(71) Applicant: Hassan LETAFAT, San Jose, CA (US)

(72) Inventor: Hassan LETAFAT, San Jose, CA (US)

(21) Appl. No.: 18/740,995

(22) Filed: Jun. 12, 2024

Related U.S. Application Data
(60) Provisional application No. 63/610,133, filed on Dec. 14, 2023.

(51) Int. Cl. E06B 3/984; E06B 3/70; E06B 3/74

(52) U.S. Cl. CPC E06B 3/984; E06B 3/74; E06B 2003/7071; E06B 2003/709

(57) ABSTRACT

Embodiments of the present invention describe novel solid core doors and methods of manufacturing solid core doors that use specialized dovetail joints to secure components of the door together to improve the sturdiness and aesthetics of the door. The manufacturing processes can include applying glue to joints between components, and pressing the door from the sides to secure the components together in a way that improves the sturdiness of the door.

### CROSS-REFERENCE TO RELATED APPLICATIONS

This application claims the benefit of and priority to U.S. Provisional Application No. 63/610,133, titled “SOLID CORE DOOR WITH DOVETAIL JOINTS AND METHOD OF MANUFACTURING THE SAME” filed on Dec. 14, 2023, which is incorporated herein by reference in its entirety.

### FIELD OF THE INVENTION

Embodiments of the present invention generally relate to the field of doors. More specifically, embodiments relate to solid core doors and the manufacturing of said doors.

### BACKGROUND

Typical doors often consist of several different pieces that are joined together during manufacturing to make the final product. The pieces that make up the door are usually wood or fiberboard. Compared to hollow core doors, solid core doors often feature a wheat, OSB, or particleboard interior core to provide sound absorption using a wood frame. These doors are relatively heavy and provide a high level of sound insulation. Some solid core doors use engineered wood to create stiles and rails with exterior panels made from MDF or wood veneer, for example, to provide an elegant finish and a high level of craftsmanship.

Unfortunately, existing approaches to manufacturing solid core doors with rails and stiles typically employ stiles consisting of several different pieces (e.g., long sticks or planks) that are joined together. Moreover, the joints that connect the stiles to the rails often use a traditional tongue and groove design that fails to provide a solid, secure connection between components. Accordingly, there is a need in the art to more securely join door components together (e.g., rails and stiles) to form a more sturdy and durable door. Moreover, there is a desire in the art to cover and hide seams and joints in solid core doors to produce a more attractive final product.

### SUMMARY

Accordingly, embodiments of the present invention describe novel solid core doors and methods of manufacturing solid core doors that use specialized dovetail joints to secure components of the door together to improve the sturdiness and aesthetics of the door. The manufacturing processes can include applying glue to joints between components, and pressing the door from the sides to secure the components together in a way that improves the sturdiness of the door. The door can then be covered with a door cover that covers and hides the joints and connections between components.

According to one embodiment, a door is disclosed including a left door stile comprising a first dovetail channel on a right edge of the left door stile, a right door stile comprising a second dovetail channel on a left edge of the right door stile, a bottom rail comprising a first dovetail tongue on a left edge of the bottom rail and a second dovetail tongue on a right edge of the bottom rail, a door panel comprising a third dovetail tongue on a left edge of the door panel and a fourth dovetail tongue on a right edge of the door panel, and a top rail comprising a fifth dovetail tongue on a left edge of the top rail and a sixth dovetail tongue on a right edge of the top rail.

According to some embodiments, the first dovetail channel is operable to receive the first dovetail tongue, the third dovetail tongue, and the fifth dovetail tongue to secure the bottom rail, the top rail, and the door panel to the left door stile.

According to some embodiments, the second dovetail channel is operable to receive the second dovetail tongue, the fourth dovetail tongue, and the sixth dovetail tongue to secure the bottom rail, the top rail and the door panel to the right door stile.

According to some embodiments, the door includes a first door cover fixed to a front side of the left door stile, the right door stile, the top rail, and the bottom rail.

According to some embodiments, the door includes a second door cover fixed to a back side of the left door stile, the right door stile, the top rail, and the bottom rail.

According to some embodiments, the door includes a middle rail between the first and second door stiles, and between the top rail and the bottom rail.

According to some embodiments, the door includes a second door panel between the top rail and the middle rail, wherein the second door panel is supported by the middle rail.

According to some embodiments, the left door stile, the right door stile comprising a second dovetail channel on a left edge of the right door stile, the bottom rail comprising a first dovetail tongue on a left edge of the bottom rail and a second dovetail tongue on a right edge of the bottom rail, and the top rail are free of visible seams.

According to some embodiments, the first door stile, the second door stile, the door panel, the top rail, and the bottom rail are bonded together using glue.

According to another embodiment, a method of manufacturing a door is disclosed. The method includes inserting a first dovetail tongue of a bottom rail into a first dovetail channel of a first door stile, inserting a second dovetail tongue of a bottom rail into a second dovetail channel of a second door stile, inserting a door panel between the first and second door stiles, and inserting a top rail into the first and second stiles, wherein a fifth dovetail tongue of the top rail is received by the first dovetail channel, and wherein a sixth dovetail tongue of the top rail is received by the second dovetail channel.

According to some embodiments, the door panel comprises a third dovetail tongue and a fourth dovetail tongue, wherein the third dovetail tongue is received by the first dovetail channel, and wherein the fourth dovetail tongue is received by the second dovetail channel.

According to some embodiments, the method includes inserting a middle rail between the first and second door stiles.

According to some embodiments, the method includes inserting a second door panel between the first and second door stiles, wherein the second door panel is supported by the middle rail.

According to some embodiments, the method includes applying glue to the first and second dovetail channels to bond the first door stile, the second door stile, the door panel, the top rail, and the bottom rail together.

According to some embodiments, the method includes squeezing the door laterally to improve the bond between the first door stile, the second door stile, the door panel, the top rail, and the bottom rail.

According to some embodiments, the method includes affixing a first door cover to a front side of the first door stile, the second door stile, the top rail, and the bottom rail.

According to some embodiments, the method includes affixing a second door cover to a back side of the first door stile, the second door stile, the top rail, and the bottom rail.

According to some embodiments, the method includes sanding the door.

According to some embodiments, the method includes finishing the door using primer.

According to some embodiments, the third dovetail tongue and the fourth dovetail tongue comprise a square shape.

According to some embodiments, the components of the door are free of visible seems.

### DESCRIPTION OF THE DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 is a block diagram depicting an exemplary solid core door including dovetail joints according to embodiments of the present invention.

FIG. 2 is a diagram depicting isolated views of an exemplary stile, rail, and panel of a door incorporating dovetail joints for improved connection and sturdiness according to embodiments of the present invention.

FIG. 3 is a diagram depicting an exemplary stile, rail, and panel joined together using dovetail joints to tightly secure components of a solid core door according to embodiments of the present invention.

FIG. 4 shows exemplary rails, and stiles, of a door laid out before being joined with panels according to embodiments of the present invention.

FIG. 5 depicts an exemplary door cover surface made from wood according to embodiments of the present invention.

FIG. 6 depicts an exemplary door stile having a dovetail channel according to embodiments of the present invention.

FIG. 7 depicts exemplary door panels having dovetail tongues that are accommodated by the corresponding dovetail channels of a door stile according to embodiments of the present invention.

FIG. 8 is a flowchart depicting an exemplary sequence of steps of a process for manufacturing a solid core door using dovetail joints according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

Portions of the detailed description that follows are presented and discussed in terms of a method. Although steps and sequencing thereof are disclosed in a figure herein describing the operations of this method, such steps and sequencing are exemplary. Embodiments are well suited to performing various other steps or variations of the steps recited in the flowchart of the figure herein, and in a sequence other than that depicted and described herein.

### Solid Core Door with Dovetail Joints

Embodiments of the present invention describe novel solid core doors and methods of manufacturing solid core doors that use specialized dovetail joints to secure components of the door together to improve the sturdiness and aesthetics of the door. The manufacturing processes can include applying glue to joints between components, and pressing the door from the sides to secure the components together in a way that improves the sturdiness of the door. The final product is advantageously denser, more sturdy, and more durable compared to existing approaches to solid core door manufacturing.

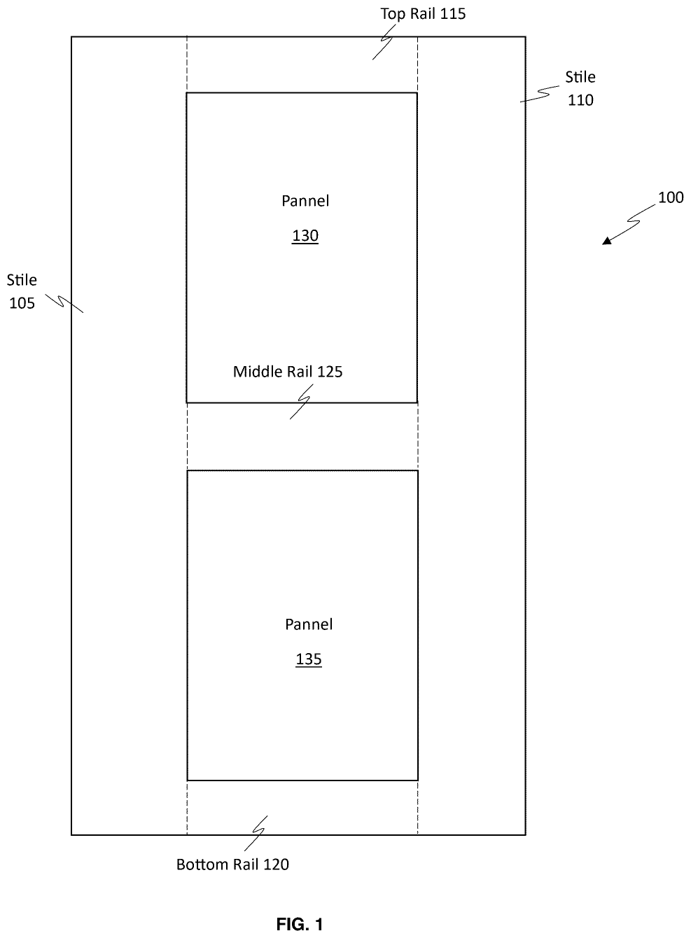

FIG. 1 is a block diagram depicting an exemplary solid core door 100 including dovetail joints according to embodiments of the present invention. The exemplary door 100 depicted in FIG. 1 is a “shaker style” door that includes two panels disposed at the center of door 100 between the stiles (left stile 105 and right stile 110) and rails (top rail 115 and bottom rail 120), and separated by middle rail 125, although fewer panels or more panels and middle rails 125 can be included according to embodiments. According to some embodiments, door 100 is constructed without any panels and without any middle rails.

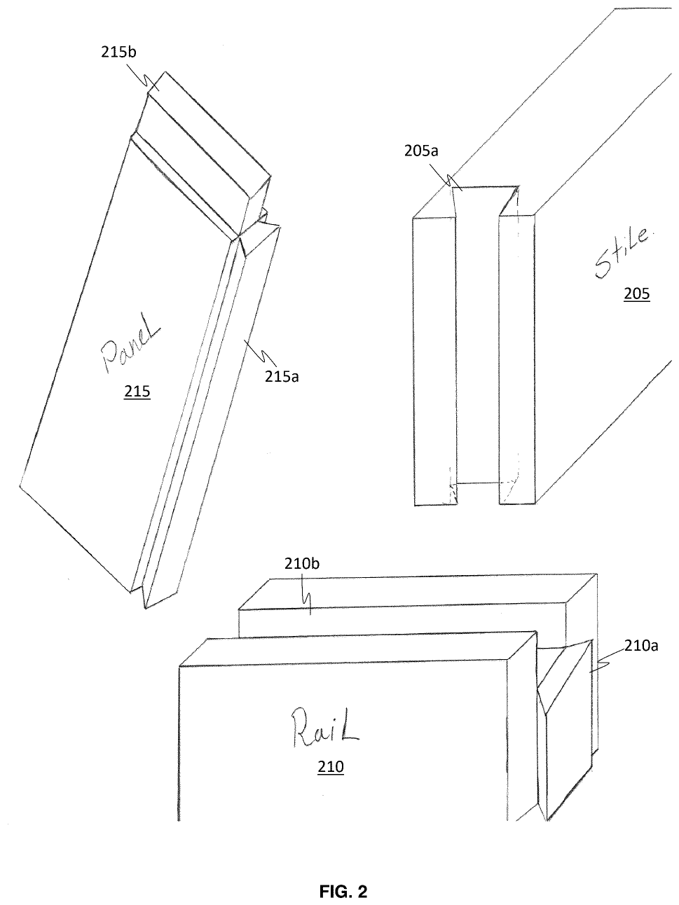

Stiles 105, 110 and rails 115, 120, 125 are typically constructed from solid wood and include dovetail groves or channels running along the interior portion of the stile (the side adjacent to panels 130 and 135). FIGS. 2-4 and 6-7 show examples of the dovetail channels that run vertically along the interior edges of the stiles to accommodate corresponding tongues of the panels and/or rails, according to embodiments. The term “dovetail” used herein describes a polygonal shape that is narrower at the base and wider at the end, and such as a dovetail tongue (protrusion) a corresponding channel having a complementary shape that tightly and securely receives the dovetail tongue. In the example of FIG. 1, by using dovetail connections between components, stiles 105, 110 and rails 115, 120, 125 are more securely connected by tension/friction due to the shape of the connections. Moreover, glue can be added to the channels and/or tongues during manufacturing to further improve the sturdiness of door 100.

The channels of stiles 105, 110 and rails 115, 120, 125 also accommodate door panels 130 and 135. According to some embodiments, panels 130, 135 include dovetail tongues running vertically along the lateral edges, and traditional (e.g., square shaped) tongues running horizontally along the top and bottom edges of the panel. In this way the vertical dovetail tongues of panels 130, 135 can slide into the corresponding dovetail channels of stiles 105, 110. Rails 115, 120, 125 include square channels to accommodate the corresponding square shaped tongues running horizontally along the top and bottom edges of 130 and 135. Therefore, the stiles, panels, and rails are secured together tightly by the joints by tension and friction during manufacturing, which can be further improved using glue and/or a press that squeezes the components together. Moreover, according to some embodiments, a cover panel is placed over stiles 105, 110 and rails 115, 120, 125 and secured using glue to cover the seams between the components.

According to some embodiments, panels 130 and 135 are substantially ¾ in. thick.

According to some embodiments, top rail 115 is 5 in. wide and bottom rail 120 is 8 in. wide.

According to some embodiments, stiles 105, 110 and rails 115, 120, 125 are the cover panel combined have a thickness of 1¾ in.

According to some embodiments, door 100 is 80 in. in total length.

According to some embodiments, door 100 is 96 in. in total length.

According to some embodiments, door 100 is finished using two coats of primer.

FIG. 2 is a diagram depicting isolated views of exemplary stile 205, rail 210, and panel 215 incorporating dovetail joints for improved connection and sturdiness according to embodiments of the present invention. As shown in FIG. 2, stile 205 includes a dovetail channel 205a that accommodates a corresponding dovetail tongue/protrusion. In the example of FIG. 2, rail 210 is a bottom rail that forms the bottom portion of a solid core door. During manufacturing, dovetail tongue/protrusion 210a of rail 210 is aligned with the channel 205a of stile 205 and moved (slid) vertically into place to join the components. Glue may be applied to further secure the components.

Similarly, dovetail tongue 215a of panel 215 is slid into dovetail channel 205a of stile 205 to secure the components together, and glue can optionally be applied. Additionally, tongue 215b of panel 215 is accommodated by channel 210b of rail 210 to secure panel 215 to rail 210. This process can then be repeated to connect another rail and another stile to complete the structure of a solid core door. According to embodiments, doors with more panels require additional rails (middle rails) to secure the panels to the door. For example, according to embodiments, a two-panel door uses three stiles, a three-panel door uses four stiles, etc. Panel 215 also includes tongues on the other edges which are not visible in FIG. 2.

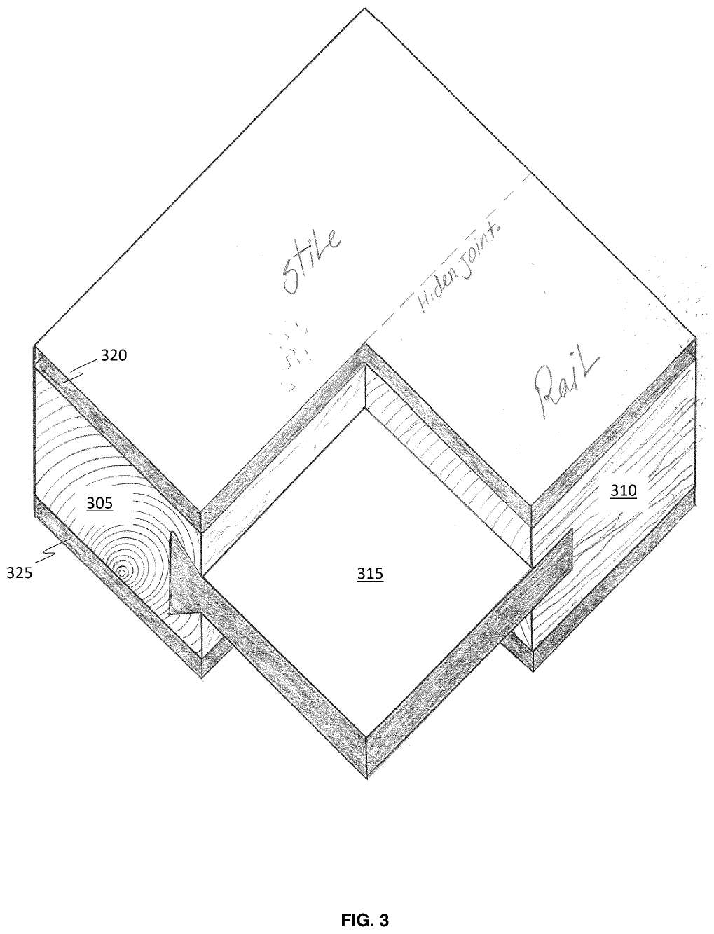

FIG. 3 is a diagram depicting an exemplary stile 305, rail 310, and panel 315 joined together using dovetail joints to tightly secure components of a solid core door according to embodiments of the present invention. As depicted in FIG. 3, stile 305 includes a dovetail channel ruining vertically that accommodates the dovetail tongues of rail 310 and panel 315, and rail 310 includes a traditional channel running horizontally that accommodates a traditional tongue of panel 315. Moreover, in the example of FIG. 3, door covers 320,325 are disposed overtop of the joined components 305, 310, and 315 on the front and back side of the door to improve the aesthetics of the door by covering the seams/joints between components, and to further improve the structural soundness and rigidity of the door. Door covers 320, 325 can be affixed to the other components using glue, for example.

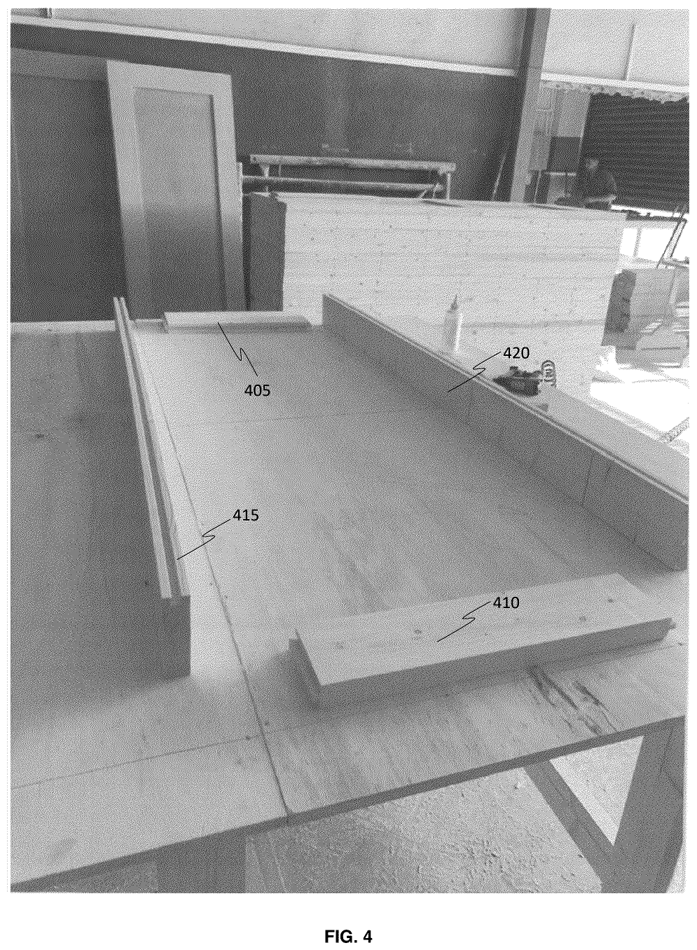

FIG. 4 shows exemplary rails 405, 410 and stiles 415, 420 laid out before being joined with panels according to embodiments of the present invention. The dovetail channels of the stiles (lateral) accommodate the dovetail tongues of the top and bottom rails to provide a solid and secure connection between components. To manufacture and construct the door, the tongues of the bottom rail 410 can be slid into the corresponding channels of the stiles 415, 420. The panel (not pictured) is then inserted by sliding the lateral dovetail tongues into the dovetail channels of the stiles 415, 420 on both sides, and a tongue on the bottom edge of the panel is accommodated by a channel on the top edge of the bottom rail 410. The top rail 405 is then placed at the top, with the lateral dovetail tongues being accommodated by the dovetail channels of the stiles 415, 420, and a channel on the bottom edge of the top rail 405 accommodates a tongue on the top edge of the panel. The interconnecting dovetail tongues and channels advantageously provide a strong and secure connection between components to improve the structure and aesthetics of the door. After the components are secured together and optionally glued in place, a door cover surface can be layered on the front and back of the connected components to hide any joints between components to improve the visual appeal of the door and add further structural rigidity.

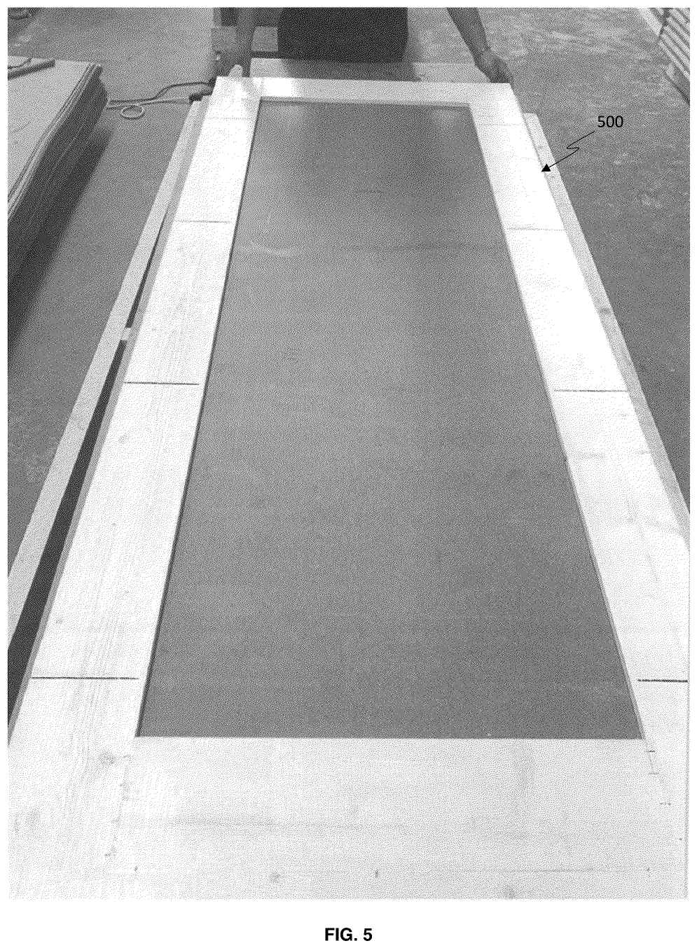

FIG. 5 depicts an exemplary door cover surface 500 made from wood according to an embodiment, although any suitable material can be used. Door cover surface can be fixed to the stiles and rails using glue, for example.

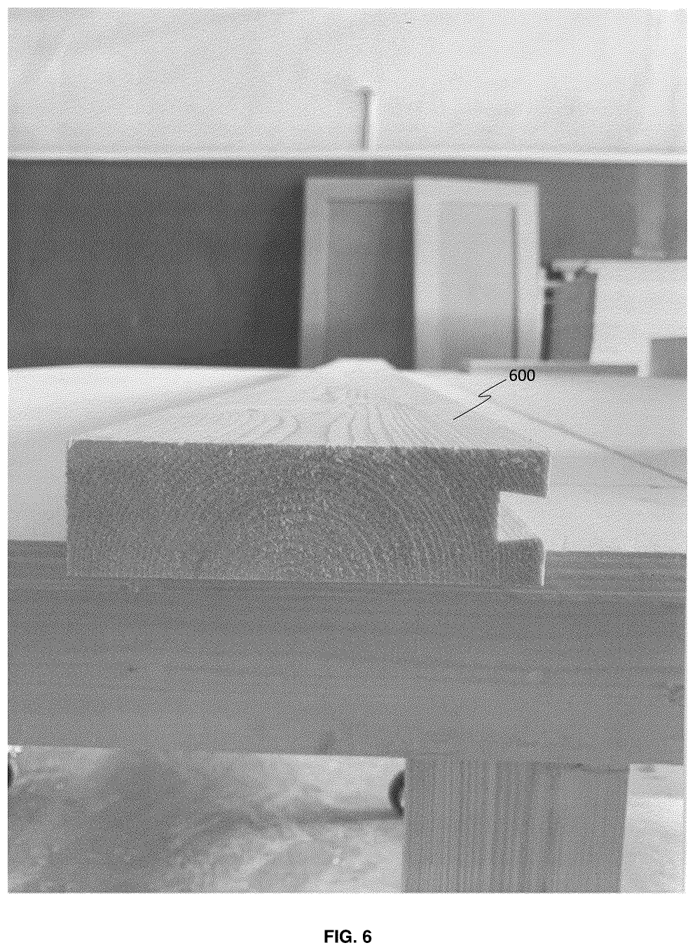

FIG. 6 depicts an exemplary door stile 600 having a dovetail channel according to embodiments of the present invention. The dovetail channel can accommodate a dovetail tongue/protrusion to securely connect door components using friction and optionally glue.

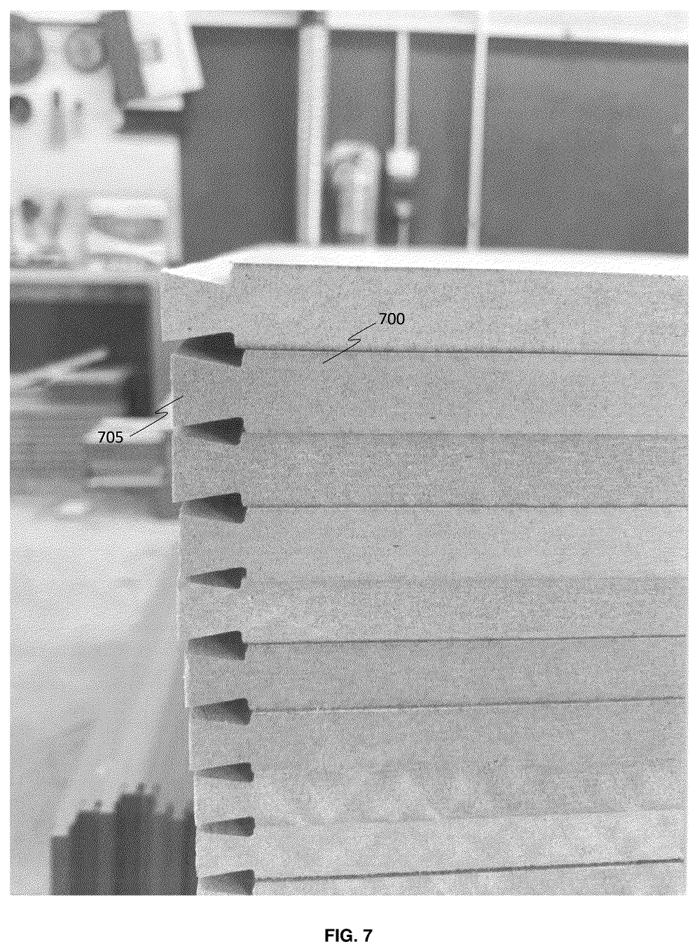

FIG. 7 depicts exemplary door panels 700 having dovetail tongues 705 that are accommodated by the corresponding dovetail channels of a door stile according to embodiments of the present invention.

### Novel Solid Core Door Manufacturing Process with Dovetail Joints

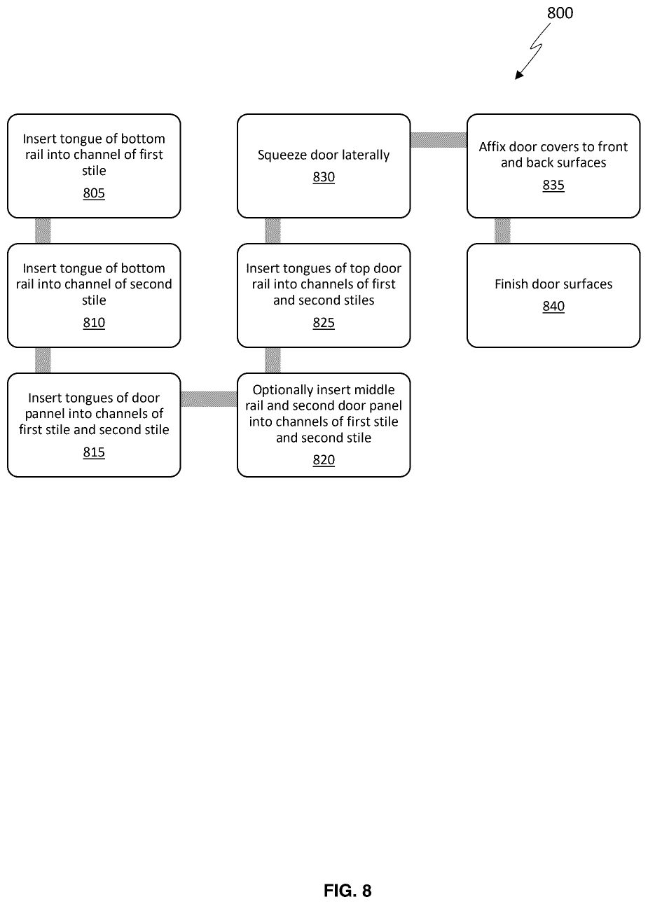

FIG. 8 is a flowchart depicting an exemplary sequence of steps of a process 800 for manufacturing a solid core door using dovetail joints according to embodiments of the present invention. Any step of process 800 can include adding glue to strengthen the bond between door components and the dovetail joints thereof.

At step 805, a dovetail tongue of a bottom door rail is inserted (e.g., slid into) into a corresponding dovetail channel of a first stile (e.g., a left stile).

At step 810, a dovetail tongue on the other side of the bottom door rail is inserted into a corresponding dovetail channel of a second stile (e.g., a right stile).

At step 815, a door panel is inserted between the door stiles and the bottom rail. Specifically, lateral dovetail tongues of the panel are slid into the dovetail channels of the first and second stiles, and a tongue on the bottom edge of the panel is accommodated by a channel on the top edge of the bottom rail.

At step 820, a middle rail is optionally inserted into the dovetail channels of the stiles to accommodate a second door panel, and the second door panel can be inserted between the stiles and supported by the middle rail. Step 820 can be repeated to accommodate up to five door panels using six total rails (one top rail, one bottom rail, and four middle rails).

At step 825, a top door rail is secured to the stiles by inserting dovetail tongues of the left and right side of the top door rail into the dovetail channels of the first and second stiles, and by inserting a tongue of the top edge of the panel into a channel of the bottom edge of the top rail.

At step 830, after the stiles, rails, and panel have been assembled, the stiles are pressed or squeezed laterally to strengthen the connection between components and improve the sturdiness of the door.

At step 835, door covers are fixed to the front and back side of the door using glue, for example.

At step 840, the door is finished by sanding surfaces of the door and adding primer, paint, stain, or the like.

Embodiments of the present invention are thus described. While the present invention has been described in particular embodiments, it should be appreciated that the present invention should not be construed as limited by such embodiments, but rather construed according to the following claims.

What is claimed is:

1. A door comprising:
a left door stile comprising a first dovetail channel on a right edge of the left door stile;
a right door stile comprising a second dovetail channel on a left edge of the right door stile;
a bottom rail comprising a first dovetail tongue on a left edge of the bottom rail and a second dovetail tongue on a right edge of the bottom rail;
a door panel comprising a third dovetail tongue on a left edge of the door panel and a fourth dovetail tongue on a right edge of the door panel; and
a top rail comprising a fifth dovetail tongue on a left edge of the top rail and a sixth dovetail tongue on a right edge of the top rail.

2. The door of claim 1, wherein the first dovetail channel is operable to receive the first dovetail tongue, the third dovetail tongue, and the fifth dovetail tongue to secure the bottom rail, the top rail, and the door panel to the left door stile.

3. The door of claim 2, wherein the second dovetail channel is operable to receive the second dovetail tongue, the fourth dovetail tongue, and the sixth dovetail tongue to secure the bottom rail, the top rail and the door panel to the right door stile.

4. The door of claim 1, further comprising a first door cover fixed to a front side of the left door stile, the right door stile, the top rail, and the bottom rail.

5. The door of claim 4, further comprising a second door cover fixed to a back side of the left door stile, the right door stile, the top rail, and the bottom rail.

6. The door of claim 1, further comprising a middle rail between the left and right door stiles, and between the top rail and the bottom rail.

7. The door of claim 6, further comprising a second door panel between the top rail and the middle rail, wherein the second door panel is supported by the middle rail.

8. The door of claim 1, wherein the left door stile, the right door stile, the bottom rail, and the top rail are free of visible seams.

9. The door of claim 1, wherein the left door stile, the second door stile, the door panel, the top rail, and the bottom rail are bonded together using glue.

10. A method of manufacturing a door, the method comprising:
inserting a first dovetail tongue of a bottom rail into a first dovetail channel of a first door stile;
inserting a second dovetail tongue of a bottom rail into a second dovetail channel of a second door stile;
inserting a door panel between the first and second door stiles; and
inserting a top rail into the first and second door stiles, wherein a fifth dovetail tongue of the top rail is received by the first dovetail channel, and wherein a sixth dovetail tongue of the top rail is received by the second dovetail channel.

11. The method of claim 10, wherein the door panel comprises a third dovetail tongue and a fourth dovetail tongue, wherein the third dovetail tongue is received by the first dovetail channel, and wherein the fourth dovetail tongue is received by the second dovetail channel.

12. The method of claim 10, further comprising inserting a middle rail between the first and second door stiles.

13. The method of claim 12, further comprising inserting a second door panel between the first and second door stiles, wherein the second door panel is supported by the middle rail.

14. The method of claim 10, further comprising applying glue to the first and second dovetail channels to bond the first door stile, the second door stile, the door panel, the top rail, and the bottom rail together.

15. The method of claim 10, further comprising squeezing the door laterally to improve bonding between the first door stile, the second door stile, the door panel, the top rail, and the bottom rail.

16. The method of claim 10, further comprising affixing a first door cover to a front side of the first door stile, the second door stile, the top rail, and the bottom rail.

17. The method of claim 16, further comprising affixing a second door cover to a back side of the first door stile, the second door stile, the top rail, and the bottom rail.

18. The method of claim 10, further comprising sanding the door.

19. The method of claim 10, further comprising finishing the door using primer.

20. The method of claim 11, wherein the third dovetail tongue and the fourth dovetail tongue comprise a square shape.
